(19) United States
(12) Patent Application Publication
(10) Pub. No.: US 2026/0059622 A1
(43) Pub. Date: Feb. 26, 2026

(54) ULTRAVIOLET CATHODLUMINESCENT SYSTEMS AND METHODS

(71) Applicant: NS Nanotech, Inc., Ann Arbor, MI (US)

(72) Inventors: Matthew STEVENSON, Chelsea, MI (US); David Arto LALEYAN, Quebec (CA); Edward Allen CABLE, Ann Arbor, MI (US)

(21) Appl. No.: 19/307,819

(22) Filed: Aug. 22, 2025

Related U.S. Application Data
(60) Provisional application No. 63/686,667, filed on Aug. 23, 2024.

(51) Int. Cl. H05B 39/04; H01K 1/28; H01K 1/54

(52) U.S. Cl. CPC H05B 39/041; H01K 1/28; H01K 1/54

(57) ABSTRACT

The invention provides cathodoluminescent lamps with improved optical stability and extended lifetimes through advanced enclosure and electron emission configurations. A filament emits electrons via thermionic emission, which are accelerated by an anode toward a cathodoluminescent emitter to produce photons. The vacuum enclosure comprises glass, fused silica, and metal portions coupled with vacuum-compatible epoxy, with the metal providing thermal and electrical conduction. The lamp can include anode current monitoring and filament power control to stabilize emission. An electrically activated getter maintains vacuum conditions by chemically bonding contaminants and can be refreshed over time. The designs enable effective vacuum maintenance, stable operation, and long-term reliability suitable for commercial applications.

### CROSS-REFERENCE TO RELATED APPLICATIONS

This Application claims the benefit of U.S. Provisional Ser. No. 63/686,667 filed Aug. 23, 2024, which is incorporated herein in its entirety.

### BACKGROUND

The use of ultraviolet (UV) light for applications such as disinfection has become an area of significant interest. UV light in the approximate range of 200 to 230 nanometers exhibits strong germicidal properties while remaining essentially harmless to human skin and eyes. However, conventional vacuum tube technologies are generally not suitable for generating or emitting light within this spectral range. Traditional vacuum envelope materials such as glass and metal are often unsuitable because they lack sufficient transparency at these wavelengths and can present challenges related to thermal cycling. Furthermore, maintaining appropriate vacuum levels in conventional devices is difficult due to issues such as seal integrity and contamination removal. In addition, conventional approaches often struggle to provide stable and consistent optical output over time.

### SUMMARY

Embodiments according to the present invention provide efficient and effective enclosure configurations (e.g., coupling of enclosure materials, removal of vacuum contaminants, etc.) and maintenance of optical output stability. In some embodiments, thermionic emission of electrons from a filament is utilized as an electron source and the electrons are accelerated via a strong electric field towards an emissive material which produces desired cathodoluminescence. The disclosed materials and configurations can have a desirably long operating lifetime that satisfies the requirements for a commercial product. In some embodiments, a cathodoluminescent lamp includes a filament configured to emit electrons responsive to a voltage applied across the filament, an anode configured to attract electrons emitted from the filament, an emitter comprising cathodoluminescent material configured to emit photons responsive to stimulation from the electrons, and a vacuum envelope/enclosure configured to enclose the filament, anode, and emitter, and to maintain a vacuum over a path of the electrons. In some exemplary implementations, the filament comprises a wire with a smooth surface.

In some embodiments, an enclosure encloses the filament, anode and emitter, wherein the enclosure comprises a glass portion, a fused silica portion, and a metal portion coupled to the glass portion and the fused silica portion. The metal portion is coupled to the glass portion and the silica portion by a vacuum compatible epoxy. In some exemplary implementations, the glass portion and the silica portion are coupled to the metal portion along their respective outer edges to a lip formed in the metal portion. The metal portion is electrically and thermally conductive.

In some embodiments, a lamp is coupled to an anode current monitor that monitors the anode current and a power supply control that controls power to the filament based upon feedback from the anode current monitor. In some exemplary implementations, a voltage supplied to the anode is held constant while power supplied to the filament is controlled. The power supply control of the filament can direct stabilization of the anode current at a pre-determined value.

In some embodiments, a lamp comprising an enclosure (that encloses a filament, anode, and emitter and forms a vacuum) and a getter that assists in maintaining a vacuum level, wherein the getter is electrically activated. The getter chemically bonds to chemicals inside the enclosure. The getter comprises a mechanism of operation that refreshes the getter over time by the application of electrical power. It is appreciated there are various approaches to supplying current to the getter (e.g. continuously applied, periodically applied, etc.). In some exemplary implementations, the getter acts as a chemical pump.

### BRIEF DESCRIPTION OF DRAWINGS

The accompanying drawings, which are incorporated in and form a part of this specification and in which like numerals depict like elements, illustrate embodiments of the present disclosure and, together with the detailed description, serve to explain the principles of the disclosure. The drawings are not necessarily to scale.

FIG. 1 is a block diagram of an exemplary lamp, in accordance with some embodiments of the present invention.

FIG. 2 is a cross section of an exemplary fused silica-metal-glass coupling joint 200 in accordance with some embodiments of the present invention.

FIG. 3 is an illustration of an exemplary lamp with a fused silica-metal-glass coupling joint in accordance with some embodiments of the present invention.

FIG. 4 is a block diagram of an exemplary control system in accordance with some embodiments of the present invention.

FIG. 5 shows an example plot of device output power versus time which illustrates the improved stability derived from this approach in accordance with some embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

The figures are not necessarily drawn to scale, and only portions of the devices and structures depicted, as well as the various layers that form those structures, are shown. For simplicity of discussion and illustration, only one or two devices or structures may be described, although in actuality more than one or two devices or structures may be present or formed. Also, while certain elements, components, and layers are discussed, embodiments according to the invention are not limited to those elements, components, and layers. For example, there may be other elements, components, layers, and the like in addition to those discussed.

As used herein, the terms “cathodoluminescent” or “cathodoluminescence” refer to materials or processes in which electrons stimulate a material to produce photons. These terms do not necessarily imply that such materials are or form an electrical cathode. In some embodiments, the photons or light from the emitter have a wavelength in a range of 200 to 230 nanometers (nm). In some implementations, a portion of the vacuum envelope, such as a faceplate, is transparent to the photons. In certain embodiments, the filament is configured to operate at a temperature greater than 1800 K, and the lamp is configured to apply a voltage of at least 1 kV between the anode and the cathode. The enclosure can include a spacer tube configured to electrically insulate and physically separate the anode from the cathode, wherein the spacer tube is further configured to withstand a voltage greater than 1 kV.

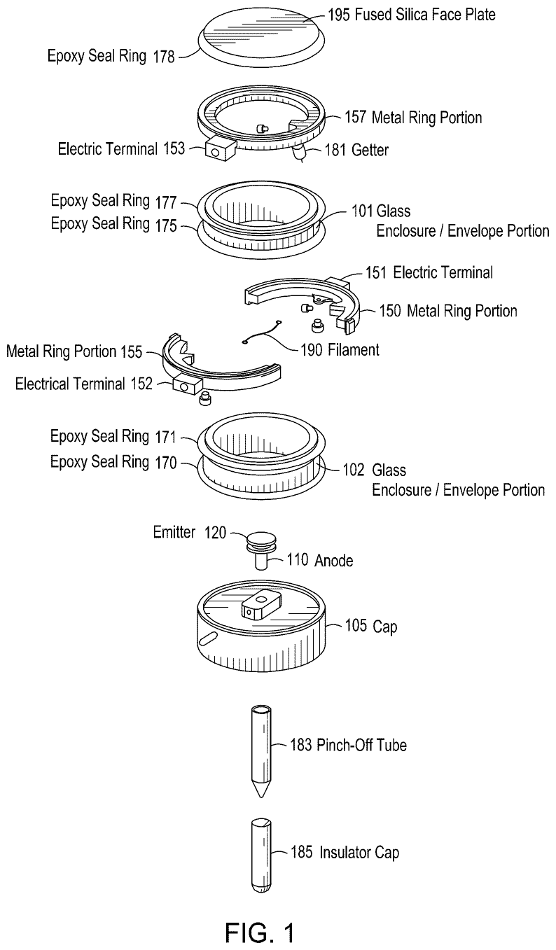

FIG. 1 is a block diagram of an exemplary lamp 100, in accordance with some embodiments of the present invention. The lamp includes anode 110, emitter 120, filament 190, getter 181, and an enclosure. The enclosure includes enclosure cap 105, glass enclosure portion 101, glass enclosure portion 102, and fused silica faceplate 195. The lamp further includes metal ring portion 150, metal ring portion 155, and metal ring portion 157. The metal ring portions, such as portions 150 and 152, are coupled to corresponding enclosure components including fused silica faceplate 195, enclosure cap 105, and glass enclosure portions 101 and 102 by respective epoxy portions such as 170, 171, 175, 177, and 178. In some embodiments, the epoxy portions form epoxy seal rings. The metal ring portions are also electrically coupled to electrical power supplies and control circuitry via electrical terminals such as 151, 152, and 153. In certain embodiments, filament 190 is coupled to metal ring portion 150 and metal ring portion 155. In some embodiments, emitter 120 is coupled to anode 110, which is in turn coupled to cap 105. In certain implementations, lamp 100 also includes pinch-off component 183 and insulator cap 185.

Filament 190 acts as a source of electrons when heated to a temperature sufficient for thermionic emission. Heating may be accomplished by application of a filament voltage or by a separate heater. In some embodiments, heating is adjusted based on factors such as characteristics of the filament material, electron flux, and limitations of blackbody emissions from the filament. In certain implementations, filament 190 serves as the cathode of the device. In some implementations, filament 190 does not operate as a field emitter type cathode and therefore lacks sharp points or features that concentrate an electric field. The filament may comprise materials such as tungsten, thoriated tungsten, carburized thoriated tungsten, lanthanated tungsten, iridized tungsten, barium, barium oxide, scandium, scandium oxide, tantalum, or molybdenum. The filament contacts are formed from thermally conductive material and have sufficient mass to function as heat sinks. The filament may be configured in a variety of shapes including a coil, arc, line, loop, spiral, or circular cross section.

Emitter 120 may comprise a layer of cathodoluminescent material that produces light when bombarded by electrons. Emitter 120 may have a smooth emitting surface. The emitter may include various emissive materials, with the specific selection depending on desired spectral characteristics. In some implementations, emitter 120 comprises a semiconductor material such as hexagonal boron nitride (h-BN), as described in U.S. patent application Ser. No. 17/009,621, entitled “Synthesis and Use of Materials for Ultraviolet Field-Emission Lamps,” which is incorporated herein by reference. Emitter 120 can be coupled to anode 110.

Anode 110 accelerates electrons from filament 190 toward emitter 120. Anode 110 is maintained at a voltage different from that of the filament, typically higher, creating an electric field that causes electron acceleration. In some embodiments, the anode layer is reflective and directs light emissions from emitter 120 outward from the lamp. In certain implementations, anode 110 also acts as a heat sink.

Enclosure 101 provides a vacuum environment within the lamp, in some embodiments at a pressure less than or equal to 10⁻⁵ Torr. At least a portion of enclosure 101, such as faceplate 195, is transparent to light in the wavelengths of interest including ultraviolet light and far-ultraviolet-C (far-UVC) light.

The lamp includes a cap configured to act as the anode, physically support the emitter, and reflect photons. In some embodiments, the cap is reflective to wavelengths in the 200 to 230 nm range and has a coefficient of thermal expansion compatible with other portions of the enclosure.

The enclosure is formed by coupling together different materials such as glass and fused silica. The fused silica faceplate has good optical transmission in the far-UVC range, allowing UV light produced by the lamp to pass through efficiently. Other portions of the enclosure, such as 101 A and 101 B, may comprise materials such as standard borosilicate glass, which are more cost effective for the main body of the lamp compared to fused silica. The coefficients of thermal expansion (CTE) for glass and fused silica differ significantly, approximately by a factor of six, and direct bonding between these materials can result in failure under thermal cycling due to induced stresses.

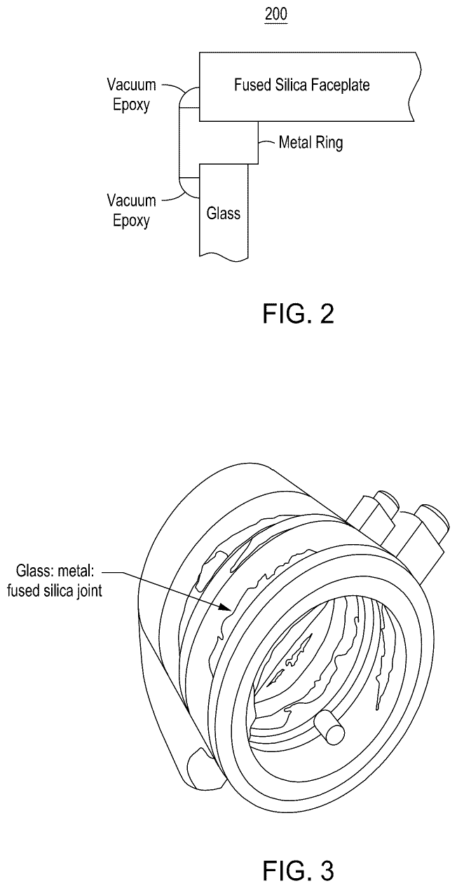

To overcome this, the materials are coupled to metal ring portions using a vacuum-compatible epoxy. FIG. 2 shows a cross section of an exemplary fused silica-metal-glass coupling joint 200. A key aspect of the design is that the glass and fused silica are not coupled face-on to the ring alone, but are coupled near their outer diameters to a lip formed in the metal ring. This configuration allows flexure of the ring during thermal cycling, producing a more robust joint than a direct glass-epoxy-fused silica bond. During thermal cycling, whether during manufacture or during lamp operation, the joint provides adequate elasticity to accommodate temperature changes from approximately 25° C. to 120° C.

FIG. 3 illustrates an exemplary lamp 300 with a fused silica-metal-glass coupling joint, similar to lamp 100 and coupling joint 200.

Coupling joints can be configured in various ways. In some embodiments, a coupling joint includes a contiguous metal ring forming a complete ring. In other embodiments, the joint comprises multiple metal ring portions separated by spaces or discontinuities. In some implementations, the coupling joint is configured as partial metal rings. For electrical reasons, the joint may be formed of two or more partial rings. The metal ring portions may be made of materials with good thermal and electrical conductivity, such as aluminum, stainless steel, or copper.

During lamp operation, electrons are thermally generated by applying power to the filament. UV light is produced when these electrons are accelerated by the anode voltage and bombard the emitter. The electron flow constitutes the anode current. In one mode of operation, the anode current magnitude is controlled primarily by the filament temperature, which depends on filament power. Thus, at a fixed anode voltage, the emitted light intensity is controlled by adjusting filament power.

Stable optical output power is desirable for a light-emitting device. Maintaining a constant anode current improves stability. In some embodiments, a lamp includes active anode current control achieved by driver electronics that monitor anode current and adjust filament power accordingly. This approach stabilizes the lamp output over time.

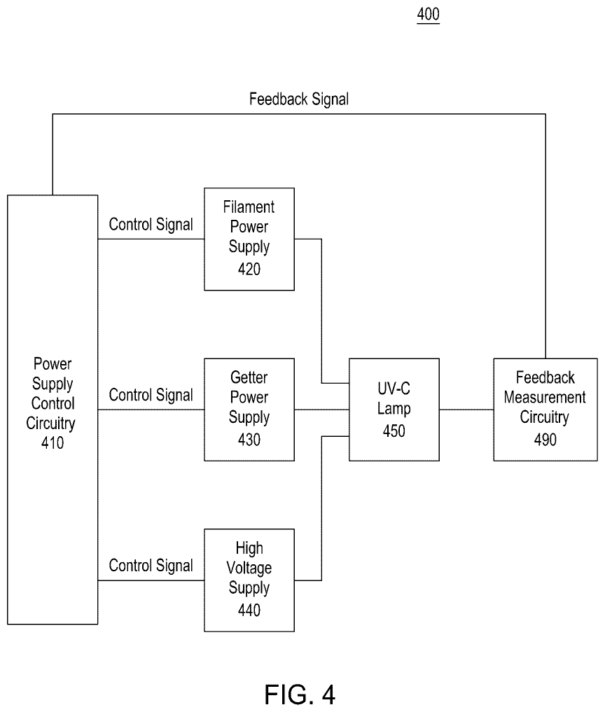

FIG. 4 is a block diagram of an exemplary control system 400. Control system 400 includes power supply control circuitry 410, filament power supply 420, getter power supply 430, high voltage supply 440, lamp components 450, and feedback measurement circuitry 490. Power supply control circuitry 410 directs filament power supply 420, getter power supply 430, and high voltage supply 440 to provide power to lamp components 450, which include the filament, emitter, and anode. Feedback measurement circuitry monitors parameters such as anode current and temperature, and power supply control circuitry 410 adjusts control signals accordingly.

In some embodiments, a lamp also includes a control grid electrode disposed between the anode and the filament to assist in regulating electron flow from the filament to the emitter.

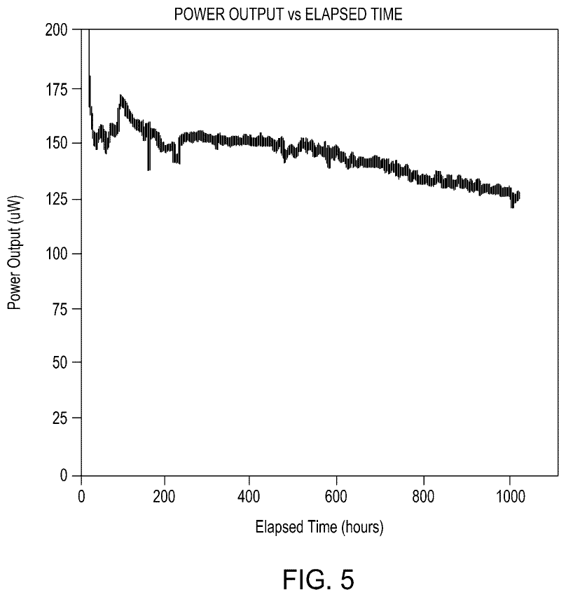

In certain implementations, the control system includes a microcontroller, such as a Raspberry Pi or Arduino, as part of the driver. The microcontroller may implement adjustments that facilitate anode current stabilization. Equivalent functionality may be achieved by an analog circuit. FIG. 5 shows an example plot of output power versus time, illustrating improved stability resulting from this approach.

In some embodiments, a getter is included inside the enclosure to maintain vacuum levels during lamp operation. A getter is a material that chemically bonds to contaminants such as water or oxygen, removing them from the internal atmosphere. Traditional vacuum tube getters are activated once and operate until exhausted. In contrast, the getter described herein is electrically activated and can be refreshed over time through the application of electrical power. Heating the getter by electrical current drives reactive chemicals to the surface while pulling exhausted reaction products into the bulk material.

Current may be supplied to the getter continuously or periodically. Continuous application of current can cause the getter to function as a chemical pump, thereby improving lamp stability. Periodic application also maintains performance by reactivating the getter during operation. In some embodiments, getter activation is controlled based on monitored lamp parameters such as output performance or voltage changes across the filament.

The lamps and components described herein share similarities with those disclosed in the following applications, each of which is incorporated herein by reference:

USPTO Application 63/345,399 filed May 24, 2022, entitled “Ultraviolet Cathodoluminescent Lamp, System and Method”;

Application PCT/US2023/023315 (WO2023109) filed May 24, 2023, entitled “Ultraviolet Cathodoluminescent Lamp, System and Method”;

USPTO Application Ser. No. 17/195,438 filed Mar. 8, 2021, entitled “Ultraviolet Field-Emission Lamps and Their Applications”;

USPTO Application Ser. No. 17/009,621 filed Sep. 1, 2020, entitled “Synthesis and Use of Materials for Ultraviolet Field-Emission Lamps”;

USPTO Application Ser. No. 63/071,810 filed Aug. 28, 2020, entitled “Synthesis and Use of Materials for Ultraviolet Field-Emission Lamps and Ultraviolet Field-Emission Lamps and Their Applications.”

In certain embodiments, the present disclosure addresses long-standing limitations in ultraviolet lamp construction by employing two specific innovations. First, the enclosure is formed from a combination of glass, fused silica, and metal portions, wherein the glass and fused silica are coupled to a lip formed in the metal portion using a vacuum-compatible epoxy. This construction overcomes the problem of differing coefficients of thermal expansion between glass and fused silica, which would otherwise cause seal failure under thermal cycling, and provides a robust joint capable of maintaining vacuum integrity over extended operating lifetimes. Second, the lamp includes a getter that is not limited to a one-time activation as in traditional vacuum devices but is electrically activated in a manner that allows it to be refreshed during operation. Application of electrical current to the getter drives reactive species to the surface of the getter material, thereby replenishing its effectiveness and permitting it to act as a chemical pump that continuously or periodically removes contaminants. These combined innovations provide durable, cost-effective ultraviolet lamps with stable optical output and long operational lifetimes not achievable with conventional designs.

In addition to the enclosure construction and the refreshable getter, embodiments of the present disclosure also provide a control system that actively stabilizes lamp output by regulating anode current. Conventional ultraviolet lamps often experience output drift because filament heating and electron emission vary with time, temperature, and operating conditions, which directly affects anode current and corresponding optical power. In contrast, the disclosed system incorporates an anode current monitor that continuously or periodically measures the anode current during operation and a power supply control that adjusts the power delivered to the filament based on this feedback. By maintaining a substantially constant anode current while holding the anode voltage fixed, the optical output of the lamp is stabilized over time, even as filament characteristics change. This feedback-driven regulation represents a significant improvement over open-loop filament drive approaches and enables predictable, long-term stability of ultraviolet emission for commercial, medical, and industrial applications.

Although the subject matter has been described in language specific to a particular exemplary embodiment or embodiments and/or methodological acts, it is to be understood that the subject matter disclosed in the present disclosure is not necessarily limited to the specific features or acts described above. Rather, the specific features and acts described above are disclosed as exemplary forms of implementing the present disclosure. Equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

Some portions of the detailed descriptions are presented in terms of procedures and other representations of operations for fabricating devices like those disclosed herein. These descriptions and representations are the means used by those skilled in the art of device fabrication to most effectively convey the substance of their work to others skilled in the art. In the present application, a procedure, operation, or the like, can be conceived to be a self-consistent sequence of steps or instructions leading to a desired result. Operations described as separate blocks may be combined and performed in the same process step (that is, in the same time interval, after the preceding process step and before the next process step). Also, the operations may be performed in a different order than the order in which they are described below. Furthermore, fabrication processes and steps may be performed along with the processes and steps discussed herein; that is, there may be a number of process steps before, in between, and/or after the steps shown and described herein. Importantly, embodiments according to the present invention can be implemented in conjunction with these other (perhaps conventional) processes and steps without significantly perturbing them. Generally speaking, embodiments according to the present invention can replace portions of a conventional process without significantly affecting peripheral processes and steps.

Embodiments according to the invention are thus described. While the present disclosure has been described in particular embodiments, the invention should not be construed as limited by such embodiments, but rather construed according to the following claims.

1. A lamp comprising:
a filament that releases electrons;
an anode that attracts the electrons;
an emitter that emits photons when impacted by the electrons; and
an enclosure that encloses the filament, anode and emitter, wherein the enclosure comprises:
a glass portion;
a fused silica portion; and
a metal portion coupled to the glass portion and the fused silica portion.

2. The lamp of claim 1, wherein the metal portion is coupled to the glass portion and the silica portion by a vacuum compatible epoxy.

3. The lamp of claim 1, wherein the glass portion and the silica portion are coupled to the metal portion along their respective outer edges to a lip formed in the metal portion.

4. The lamp of claim 1, wherein the metal portion is electrically and thermally conductive.

5. A lamp comprising:
a filament that releases electrons;
an emitter that emits photons when impacted by the electrons;
an anode that attracts the electrons creating an anode current;
an anode current monitor that monitors the anode current; and
a power supply control that controls power to the filament based upon feedback from the anode current monitor.

6. The lamp of claim 5, wherein a voltage of power supplied to the anode is held constant.

7. The lamp of claim 5, wherein the power supply control directs stabilization of the anode current at a pre-determined value.

8. A lamp comprising:
a filament that releases electrons;
an anode that attracts the electrons;
an emitter that emits photons when impacted by the electrons;
an enclosure that encloses the filament, anode and emitter, wherein the enclosure forms a vacuum within the enclosure; and
a getter that assists in maintaining a vacuum level, wherein the getter is electrically activated.

9. The lamp of claim 8, wherein the getter chemically bonds to chemicals inside the enclosure.

10. The lamp of claim 8, wherein the getter comprises a mechanism of operation that refreshes the getter over time by the application of electrical power.

11. The lamp of claim 8, wherein a current to the getter is continuously applied.

12. The lamp of claim 8, wherein the getter is a chemical pump.

13. The lamp of claim 8, wherein a current to the getter is periodically applied.

14. The lamp of claim 8, wherein a current to the getter is periodically applied during operation of the lamp.

15. A method of operating a cathodoluminescent lamp, comprising:
enclosing a filament, an anode, and a cathodoluminescent emitter within a vacuum enclosure;
applying a voltage across the filament to emit electrons via thermionic emission;
accelerating the emitted electrons toward the emitter using the anode; and
producing photons from the emitter responsive to impact from the accelerated electrons.

16. The method of claim 15, further comprising monitoring an anode current flowing between the filament and the anode.

17. The method of claim 16, further comprising controlling power supplied to the filament based on feedback from the monitored anode current to stabilize the electron emission.

18. The method of claim 15, further comprising maintaining a vacuum level within the enclosure using an electrically activated getter that chemically bonds contaminants.

19. The method of claim 18, further comprising periodically or continuously applying electrical power to refresh the getter.

20. The method of claim 15, further comprising providing the vacuum enclosure with a glass portion, a fused silica portion, and a metal portion coupled via a vacuum-compatible epoxy.

21. The method of claim 20, wherein the metal portion provides electrical and thermal conduction for the lamp.

22. The method of claim 15, further comprising holding the anode voltage constant while varying power supplied to the filament to maintain stable anode current.

23. The method of claim 15, wherein the filament comprises a wire having a smooth surface.
